(19) United States
(12) Patent Application Publication
(10) Pub. No.: US 2005/0289130 A1
(43) Pub. Date: Dec. 29, 2005

(54) Method for responding to customer queries

(76) Inventors: Darryl R. Cohen, Laguna Beach, CA (US); Mark I. Cohen, Oakland, CA (US); Dan M. Palazotto, Liberty Township, OH (US); Stephen S. Burns, Maineville, OH (US)

Correspondence Address: Welsh & Katz, Ltd.;Eric D. Cohen, 22nd Floor, 120 South Riverside Plaza, Chicago, IL, 60606, US

(21) Appl. No.: 11/165,422

(22) Filed: Jun. 23, 2005

Related U.S. Application Data
(60) Provisional application No. 60/582,366, filed on Jun. 23, 2004.

(51) Int. Cl. G06F 17/30

(52) U.S. Cl. 707/3

(57) ABSTRACT

A method for responding to customer queries using a communication network includes receiving one or more verbal queries from a customer via a customer communication device, digitizing and storing the verbal query, retrieving the stored query and transcribing the query by a human transcriber, spot-checking by a quality assurance operator of the transcribed query, and routing the transcribed query to a human researcher. The researcher than performs research using search engines, databases, and/or knowledge-bases to obtain an answer to the query. The researcher's answer may also be spot-checked by a quality assurance operator. The answer is then transmitted to the customer communication device in text format.

### CROSS-REFERENCE TO RELATED APPLICATIONS

This application claims the benefit of priority from provisional patent application Ser. No. 60/582,366, filed on Jun. 23, 2004, entitled Web-Based Method For Responding To User Queries. Application Ser. No. 60/582,366 is hereby incorporated by reference in its entirety.

### FIELD OF THE INVENTION

The present invention relates generally to a method for responding to customer queries, and more particularly, to a method that permits a user to pose a question in voice format and to receive an answer to the question in text format via an electronic communication device, such as a cellular telephone or personal digital assistant.

### BACKGROUND

It is generally known to send messages using SMS (short message system) via a cellular telephone and to send email messages via a computer. It is also known to use SMS and email in automated systems where the user sends a text query to a web sever or other service, which parses or extracts the pertinent query, forwards the formatted query to a content provider, which automatically generates an answer, and forwards it back to the user. However, it is often inconvenient for the user to type in his query, especially using the awkward key pad provided on most portable communication devices. Further, customers often type in inaccurate or cryptic questions that cannot be properly answered.

### SUMMARY

In one specific embodiment, a customer or user query may be in the form of a voice telephone call, which may then be transcribed into a properly formatted question. The user query or spoken question may be digitized into a “.wav” (“WAV file”) file, which WAV format is standard in the industry for digitized voice recordings. The WAV file may then be sent to the query and answer system as an attachment in an email, or it may be sent via FTP (file transfer protocol). The WAV file is then formatted and stored. An auto-distribution sub-system may poll for the stored email or WAV file and deliver it to a general queue table for distribution, or it may respond to an operator request. The WAV file may be sent to a transcription station where a human operator transcribes the audio information into text data, which data represents the question posed by the user to the system. A response may be automatically generated, or a human researcher may obtain the answer, and a response to the question may then be sent back to the customer via the same device that the customer used to pose the question, providing that the customer device is capable of displaying text data. Similarly, a question originally in the form of an email may also be transcribed or at least modified by a transcriber or quality assurance operator.

According to one specific embodiment, the method for responding to customer queries includes the steps of receiving one or more verbal queries from a customer via a customer communication device, digitizing and storing the verbal query, retrieving the stored query and transcribing the query by a human transcriber, spot-checking the transcribed query by a quality assurance operator, and routing the transcribed query to a human researcher. The researcher then performs research using search engines, databases, and/or knowledge-bases to obtain an answer to the query. The researcher's answer may also be spot-checked by a quality assurance operator. The answer is then transmitted to the customer communication device in text format.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a block diagram of a specific embodiment of a customer query and answer system, according to the present invention;

FIG. 2 is a block diagram of a specific embodiment of a customer query and answer system;

FIG. 3 is a high level flowchart according to one embodiment of a method of the present invention illustrating handling of an incoming customer query; and

FIG. 4 is a high level flowchart according to one embodiment of a method of the present invention illustrating servicing of a customer query.

### DETAILED DESCRIPTION

In this written description, the use of the disjunctive is intended to include the conjunctive. The use of definite or indefinite articles is not intended to indicate cardinality. In particular, a reference to “the” object or thing or “an” object or “a” thing is intended to also describe a plurality of such objects or things.

### SUMMARY

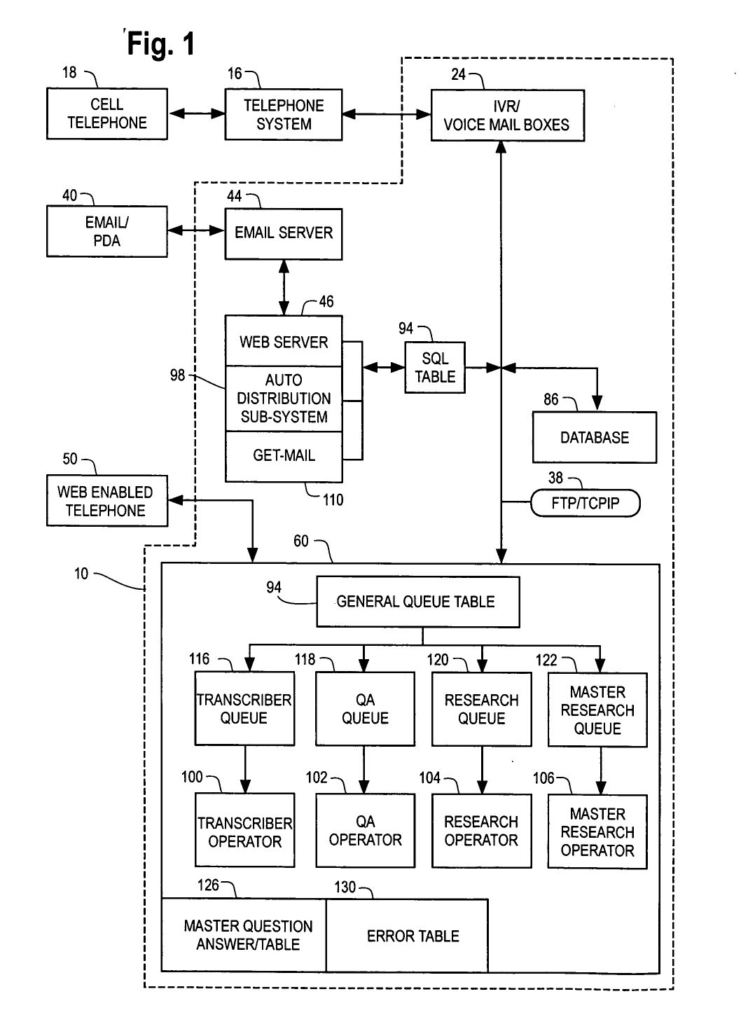

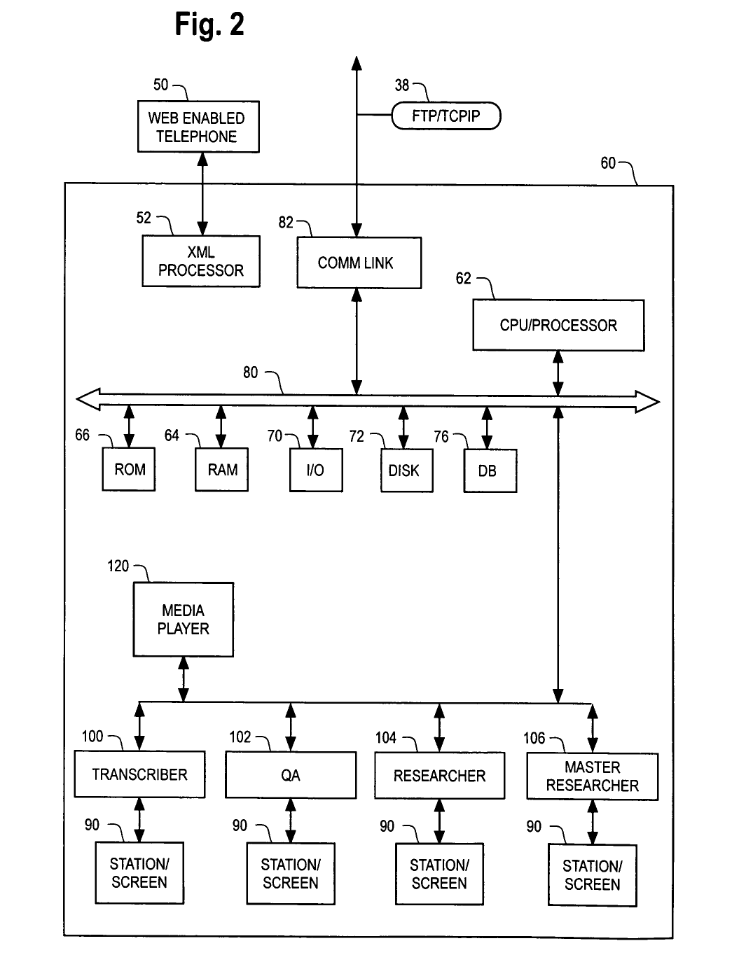

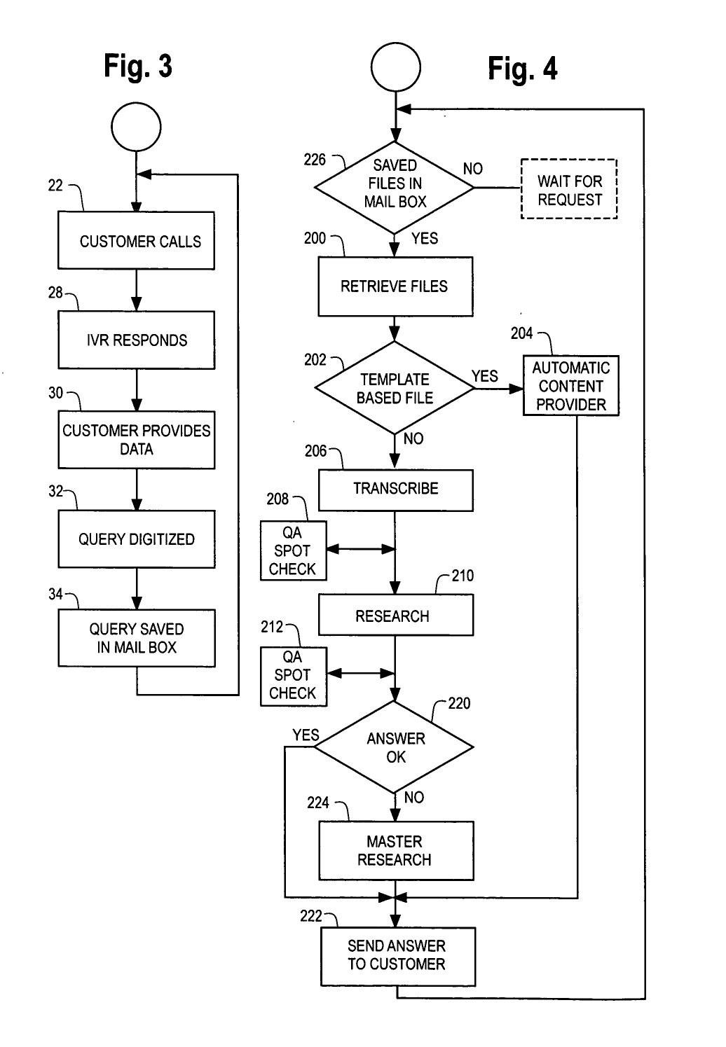

Referring now to FIGS. 1-3, a query and answer system 10 for responding to user queries is shown in a high-level block diagram. FIG. 3 is a high level flow chart illustrating certain actions by the customer and the system. A user or customer may communicate with an established telephone system 16 using either a land line or a cellular telephone 18 (see step 22, FIG. 3). An interactive voice response (IVR) 24 device coupled to the telephone system 16 provides prompts to the caller (see step 28, FIG. 3), and the caller records a voice message or question (see step 30, FIG. 3), which is digitized stored by the IVR (see steps 32 and 34, FIG. 3). The IVR 24 is, in turn, operatively coupled to the query and answer system 10 via FTP (file transfer protocol) preferably using TCPIP protocol 38, as is known in the art.

The customer may also use a personal digital assistant (PDA) 40 or any suitable communication device or computer to send an email. Such devices preferably communicate with an email server 44, which may be, in turn, operatively coupled to a web-server 46. The web-server may be, in turn, operatively coupled to the query and answer system 10 via FTP as described above. Similarly, the email server 44 may provide prompts to the user or customer to provide certain information regarding his query.

Alternatively, the user may use a web-enabled telephone 50 or other wireless device. In this case, the transmitting device may be operatively coupled to the query and answer system 10 via an XML processor or similar application 52, which may reside in the query and answer system.

The query and answer system 10 may be implemented on a standard computer platform. The query and answer system preferably includes a computer system 60, which may be in the form of a desktop, laptop, or notebook style personal computer, such as an IBM or APPLE® brand compatible personal computer. Preferably, the computer system 60 is an IBM brand compatible personal computer, having for example, one or more microprocessors 62 running under WINDOWS, UNIX, Linux, or any other suitable operating system. The computer, however, may be any computer, processor, central processing unit (CPU), microprocessor, RISC (reduced instruction set computer), mainframe computer, work station, single chip computer, distributed processor, server, controller, micro-controller, discrete logic device, remote computer, internet computer or web computer.

The computer system 60 may include known commercially available components, such as RAM 64 (random access memory), ROM 66 (read only memory), input/output ports 70, disc storage 72, database 76 and applications, and the like. As is known in the art, the various components of the computer system are coupled to each other via one or more standard computer buses 80. Of course, multiple computers or multiple computer systems may be used to handle the processing and to distribute the processing load without departing from the scope and spirit of the invention. Also included are multiple screens or work stations 90 for the operators or attendants.

Preferably, the query and answer system 10 includes a communication link 82 to operatively couple the computer system 60 to external devices via FTP using TCPIP protocol, as is known in the art. The query and answer system 10 may also include one or more internal databases 76 or external databases 86 (FIG. 1).

In one specific embodiment, the query and answer system 10 is preferably operatively coupled to the voice mail system of the IVR 24, and is configured to receive a recorded voice message from a customer. Using the wireless telephone 18, the customer or user may dial a specific telephone number to reach the query and answer system 10. IVR device 24 may prompt the customer to select various options in accordance with a menu selection. After the customer has selected the appropriate menu choice, he may state the pertinent question, which may be recorded and digitized, and stored in a voice mail box or other storage medium in the IVR.

The caller may also poses his question via email, which email message may be received by the email server 44. The email may be parsed and appended into a SQL table 94 (Structured Query Language), in which an indication is set informing the system that this query has not yet been answered. The Structured Query Language may be written in Microsoft SQL Server 2000.

A web services application referred to as the “auto-distribution” 98 or the “auto-distribution sub-system” may run as a background program on the web-server. This application may be written utilizing Microsoft .NET Technology, Version 1.1. The auto-distribution sub-system 98 may be operatively coupled to a transcription sub-system 100, a quality assurance (QA) sub-system 102, a research sub-system 104, and a master research sub-system 106. The above mentioned sub-systems may be software applications written utilizing Microsoft NET Technology, Version 1.1.

The auto-distribution sub-system 98 may query the email server 44 to obtain the email questions. To accomplish this, a polling application, referred to as “get-mail” 110 is preferably running in the background on the web-server 46, which is operatively coupled to the email server. The get-mail application 110 may poll the various mail boxes to obtain the questions posed by the customers, whether in the form of voice mail from the IVR 24 or in the form of email from the web-sever 46. Preferably, the get-mail application 110 polls the email server 44 and/or the IVR 24 only when there is a minimum number of messages or questions stored in a queue 94. For example, when the queue 94 has been depleted so that only thirty messages remain, for example, the get-mail application may perform the polling process to obtain additional messages with which to populate the queue. Alternatively, if no additional messages are waiting to be serviced, polling may be suspended for a predetermined period of time, for example, three minutes. This saves system resources.

The get-mail application 110 may then forward the question to the auto-distribution sub-system 98 for further routing to the various stations or operators, namely, the transcriber station or operator 100, the quality assurance station (QA) or operator 102, the research station or operator 104, and the master research station or operator 106. The get-mail application may be written utilizing Microsoft NET Technology, Version 1.1.

Preferably each operator or station (i.e, transcriber, quality assurance, research and master research) initiates distribution of a question via clicking of a “get question” button or icon on the operator's display screen 90. A request is then made to the auto-distribution sub-system 98 to retrieve a question from the queue 94 and distribute it to the requesting operator. Preferably, the question is stored in an operator queue corresponding to each type of operator. Thus, a transcriber queue 116, a QA queue 118, a researcher queue 120, and a master researcher queue 122 are provided for the corresponding operators. The auto-distribution sub-system 90 provides two functions. First, the auto-distribution sub-system 90 may receive a request from the station or operator and immediately query the email server 44 for messages (questions) that have populated the in-box. These questions may then be parsed into a readable format, which may be appended into the “general queue” SQL table 94. Second, the auto-distribution sub-system 98 may receive a request from the transcriber station 100 and immediately query an FTP directory for voice mail questions in the form of a WAV file. These questions are then assigned an identifier or key ID, which may be appended into the general queue SQL table 94.

If the customer poses the question via a web-enabled telephone 50, the telephone may be operatively coupled directly to the XML processing application 52 residing on the query and answer system 10. The XML processor application 52 may be written utilizing Microsoft .NET Technology, Version 1.1.

Regardless of the type of device used by the customer to communicate with the query and answer system 10, the question is handled by the auto-distribution sub-system 98. Again, such questions or customer queries may be in the form of a WAV file, an email, an XML data string or other text format.

In an alternate embodiment, rather that the operator stations (100, 102, 104, 106) requesting a question or query from the auto-distribution sub-system 98, the auto-distribution may deliver the questions to the stations without a specific request, based on certain criteria. The auto-distribution sub-system may poll the various stations, such as the transcription station 100, the research station 102, the quality assurance (QA) station 104, and the master research station 106, to determine resource availability. The auto-distribution sub-system 98 may determine which operators are logged into the system, which operators are idle, and which operators are available to handle the queries at their respective station, and may deliver the queries to the various stations based on longest idle time, or other suitable criteria.

In the case where the customer communicates using a voice-based device, such as a cellular telephone 18, a WAV file is created and stored by the IVR 24. The WAV file can be in a template format or in a “free form” format. With template files, the form of the question dictates certain information to be included in the template. On the other hand, free form questions are not suitable for a fixed format template, and thus are interpreted and researched by a human operator.

Regarding template-suitable questions, for example, thirteen categories of questions may be provided, which represent commonly asked questions, such as category 1 for “weather,” category 2 for stocks, and the like. Any suitable number or identifier may be assigned to the particular categories. If the customer's question can easily fit into a particular category of questions provided by the system, the user may select this category type in response to prompts provided by the IVR 24 in accordance with a menu selection. For example, the IVR 24 may direct the customer to type or say the number 1 if his question is a weather related question, or type or say the number 2 if the question is a stock related question, and the like. If no standard category is suitable, the user can select a “free form” category, which may be, for example, category number 14, as will be described later. However, any suitable number of categories may be provided.

The following list illustrates some of the possible categories which may be presented to the customer by the IVR 24. The list may be ordered according to the known frequency of such questions asked by callers. Of course, this is not an exhaustive list, and any suitable or practical number of categories may be provided, as follows:
1. Weather
2. Stock Quote
3. Sports Scores
4. Directory Assistance
5. Directions
6. Horoscope
7. Restaurants
8. Flights—Fares
9. Flights—Arrival & Dep. Info
10. Accommodations
11. Movie Timetables
12. Comparison Shopping
13. Vegas Odds
14. Free form questions

Preferably, the file name of the WAV file incorporates the category selected. In one specific embodiment, the first two digits of the file name of the WAV file reflects the category number. Accordingly, the file name of the digital recording of the caller's voice, that is, the WAV file of the digitized voice recording, may then reflect the selected category. For example, the name of the WAV file may begin with the digits 01 if the file represents a weather related query.

Additionally, when the user calls the query and answer system 10, the ANI (automatic number identification) field is interrogated to provide the system with the caller's telephone number (caller ID). The customer's telephone number may then be used to access the customer database 86 to locate the customer's account number. Preferably, the customer's account number also forms part of the WAV file name, and preferably follows the category identifier as part of the file name. For example, if the customer's telephone number is (312) 555-5555 and the question concerns weather, the WAV file may be assigned, for example, the file name of 013125555555.wav. Interrogation of the database corresponding to the customer account may determine if the user has paid the required fees.

After the WAV file has been assigned a name, it may then be sent to a particular transcriber 100 via the auto-distribution sub-system 98 for transcription by a human operator, either based on a request for question from the transcriber (via clicking of the get-question icon or button) or by criteria-based automatic forwarding of the message by the auto-distribution sub-system. The WAV file may be placed in the transcriber queue 116 for each selected transcriber via the auto-distribution system. The transcriber 100 may be informed of the arrival of the new question (i.e., new file) by a suitable audio sound or a visual alert presented on the transcriber's screen 90. Preferably, each transcriber 100 has his own queue 116. The transcriber queue 116 may be shown on the transcriber's monitor 90 in a suitable sequential order, preferably in FIFO order (first-in first-out or oldest on top) so that the oldest WAV files are serviced sooner. The transcriber 100 may then click on the icon representing the WAV file in the queue to listen to the digitized recording. Clicking on the icon representing the WAV file may activate an embedded WAV media player 120 running on operator's station system to permit the operator to listen to the contents of the WAV file. The WAV media player is a commercially available product, for example, Windows Media Player, version 10, by Microsoft. Preferably, the operator listens to the WAV file through a headphone set, but any suitable apparatus may be used.

In some situations, the caller's question may be unintelligible, either due to a poor telephonic connection or because the caller may not be speaking properly or cannot be otherwise understood by the transcriber 100. In such an event, the transcriber 100 may enter an error code so that the file will be sent to the quality assurance (“QA”) operator 102 for further processing. The QA operator will know that the transcriber was not able to discern the question based on the error code. Accordingly, the QA operator 102 may verify this condition by similarly reviewing the WAV file, and if he agrees that the question was not discernable, the QA operator may click a button that provides an automatic response to the caller informing the caller to call back and repeat his query. Alternatively, the QA operator 102 may be able to discern the question that the transcriber was not able to discern, and if so, the QA operator may finish the transcription at the QA station. Note that the QA operator 102 may perform spot-checks on the work product of the transcriber, and generally need not review every transcription. However, the QA operator preferably reviews all transcriptions for which the transcriber 100 has set the error code.

Obviously, if the customer is communicating using a non-voice based device, such as by email or a web-enable telephone, no voice message is recorded and no WAV file is created. However, the text-based messages transmitted by the customer and handled by the auto-distribution sub-system may nonetheless be forwarded to the transcription operator 100 to effectively “clean up” or otherwise edit and improve the content of the text query.

Note that when the WAV file or other text-based file is directed to the transcription station 100, it is preferably routed to the transcriber having the longest idle time. However, any suitable method of determining routing may be used, as will be described in greater detail hereinafter.

Because the name given to the WAV file or other text-based file may include the category of the customer query, clicking on the file by the operator may invoke some automatic action based on that category. The template corresponding to the selected category may provide a particular GUI (graphic user interface) to the operator, which may, for example, include entry or dialog boxes. For example, most weather related queries are based on the zip code to identify the geographical area to which the customer's weather question pertains. Thus, the template may provide an entry box into which the transcriber enters the zip code. Once the specific template is filled in by the transcriber, the transcriber may click a “send button” which forwards the template to the QA station or operator, as will be described later.

Regarding the underlying structure for the template, preferably, the data and template are XML based, thus it is relatively universal in nature, which permits the query to be “understood” by a content provider.

The following list illustrates some of the templates and sub-templates corresponding to the various categories mentioned above. The items listed in bullet-point format represent the entry or dialog box to be filled in by the transcriber during review of the WAV file. Of course, the list is not an exhaustive list, and any suitable or practical number of templates may be provided. Note also that the templates may be context sensitive and may provide “drill-down” levels of data. For example, if the customer selects category no. 7 (“restaurants”), further options may be presented to the customer, such as a choice of multiple cuisines (not shown in further detail).
1. Weather
   City—10 digits
   State—2 digits
   Zip—5 digits
2. Stock Quote
   Symbol—4 digits
   Company Name—10 digit
3. Sports Scores
   A. Professional
      League—Choose NBA/NFL/MLB/NHL
      City or Location—15 digits
      Team Name—10 digits or team name
      Game Date
      Retain favorite team settings
   B. College
      Sport—10 digits—Football & Basketball
      Mens/Womens
      College/University Name—15 digits
      Game Date
      Retain Favorite team settings
4. Directory Assistance—411.com
   First Name
   Last Name
   Street Number
   Street Name
   City
   State
   Zip
5. Directions—maps.com
   A. From
      Street Number
      Street Name
      City
      State
      Zip
   B. To
      Street Number
      Street Name
      City
      State
      Zip
6. Horoscope—astrology.com
   Birthdate—day
   Birthdate—mo
   Birthdate—year
7. Restaurants
   Type of cuisine (choose from drop down menus)
   City
   State
   Country (if other than US or Canada)
   zip/postal
8. Flights—lowest available ticket prices
   Round Trip or One Way
   Departure city
   Departure State
   Or Departure Airport
   Arrival city
   Arrival State
   Or Arrival Airport
   Date departing
   Time departing (enter time or choose “anytime”)
   Date returning (enter time or choose “anytime”)
9. Flights—Arrival times, should also do departure info
   Flight number
   Airline
   Departure Airport
   Arrival Airport
   Date
10. Accommodations—Names of hotels/motels and pricing
   City
   State
   Or zip code
   Check-in date
   Nights of stay (or check out date)
   Rate options (i.e.,—under $100, under $250, under $400, no limit)
11. Movie timetables
   Name of theatre; or
   City
   State
   Or zip code
   Name of movies; or all movies
   Date
12. Comparison Shopping—On-line merchants
   Name of Product and model number
13. Las Vegas Odds
   A. Professional
      League—Choose NBA/NFL/MLB/NHL
      City or Location—15 digits
      Team Name—10 digits or list all teams to choose from
      Game Date
      Retain Favorite team settings
   C. College
      Sport—10 digits—Football & Basketball
      Mens
      College/University Name—15 digits
      Be able to retain ‘Favorite’ team settings
   D. Horse Racing Track Odds
14. Free form questions
   50 characters maximum

The quality assurance operator 102 may review the WAV file (or other file) and the data entered by the transcriber to determine if all of the data appears to be correct, and thus verifies the accuracy of the transcribed question. If the data appears to be correct, the QA operator may click a button to cause the template to be sent to an automatic content provider. Note that with such template based questions, no human researcher is needed to find the answer, as contrasted with the process used with free-form questions. With respect to the prior example of a caller requesting weather related data, in this situation, the QA operator would review the template for the question posed, and if verified, would send the weather related query to the content provider. Such content providers may include: AccuWeather.com, API411, SportsDirect, FlyteSource, Money.net, Hotels.com, Maps.com, SportsNetwork.com and the like. The answer provided by the content provider may then be automatically sent back to the caller via the same medium that the user posed the question, which in the above example, may be the customer's mobile device, such as a cellular telephone or PDA (personal digital assistant). Note that the transcribed question, which may be edited by the QA operator 102, and the corresponding answer when received, may be saved to a master question/answer text table 126, for example, once per day, so as to maintain a complete historical record of all transactions.

Note that the QA operator 102 need not evaluate every transcribed question. Rather, the QA operator may perform a “spot check,” especially if the transcriber is inexperienced, is a trainee, or has a poor performance record. The results of the QA operator's review may also be maintained in an error table 130 so that corrective action, if needed, may be taken.

As mentioned above, the answer to the caller's question may be transmitted back to the caller via the same communication device used by the caller used to transmit the question. Thus, in one embodiment, the question may enter the system as a voice mail or spoken message, but the answer may be returned to the customer as a text answer transmitted to the customer's cellular telephone. Of course, this assumes that the customer's cellular telephone is capable of displaying text or other graphic messages. In another embodiment, the question may enter the system as a text message (SMS or email), and thus, the answer may be returned to the customer as a text answer. In either embodiment, the question is routed via the auto-distribution sub-system, to the transcriber station 100, the researcher station 104 if a free-from question, the master research station 106 if needed, and to the quality assurance station 102, on a spot-check basis.

As mentioned above, the WAV file may be in a template format or a “free-form” format. Free form questions are questions that do not conveniently fit into a specific template, and may be treated more like a “trivia” question. For example, the customer may call the query and answer system 10 and pose the following question: “what was the birth state of the 14^{th} president of the United States.” Again, as above, the WAV file may be sent to the transcriber for human transcription. These types of queries are preferably answered by a human researcher, and not automatically by the content provider due to their nature and level of difficulty. As is similar to template-suitable questions described above, the free-form question is also transcribed by the transcription operator 100 and may be spot-checked by the QA operator 102 for verification and accuracy. As mentioned in the above example, the file name of the WAV file may begin with the digits 14 to indicate that it is a free-form question rather than a template based question.

Once the transcription of the question is complete, or has been verified by the QA operator if spot-checked, it may then be forwarded to the research queue 120 via the auto-distribution sub-system 98 so that a human operator may research the question to obtain a suitable answer.

Preferably, for free form categories, the transcriber 100 can use his judgment and assign a free-form category, if applicable, to the question. This may be done for very frequently asked classes of free-form questions, and a popularity identifier may assigned to such questions. For example, the transcriber may recognize that the query is certainly a free form question, but may also recognize that it is a sports, history, or travel question, which are commonly asked questions. This permits routing the question to a particular researcher 104 who may be more efficient because the particular researcher may have some expertise in this area. For example, a particular researcher may be a sports trivia expert, who can more quickly obtain the answer to the query. Preferably, that particular researcher will receive the majority of the sports related free form questions.

After a particular WAV file representing a free form question has been transcribed, the transcribed question or query may be sent to the research queue 120. The transcribed free form query may be routed to the “researcher” on a “First Come-First Serve” methodology. All stations (Transcriber, Researcher, QA) preferable include the “get-question” button or icon on their display screen 90, that when clicked on, will trigger the events described above regarding the auto-distribution sub-system and the get-mail application. The question or query forwarded to the researcher includes all of the parameters used to populate the display screen or workstation screen. Preferably, a “first-come first-serve” methodology is used, but any suitable methodology may be used, such as a “strength of category” ranking, which accounts for particular knowledge strengths by the individual researcher. Each research operator may be graded on their accuracy and speed of each question answered, and this grade or value may be assigned a ranking per category.

As described above, in one specific embodiment, when the researcher 104 is available to service a question in his queue 120, the researcher may then click on the icon on his screen representing the transcribed query (i.e., the WAV file) residing in the research queue. The text of the transcribed query may then be displayed to the researcher. The researcher may then begin to perform research to obtain an answer to the question. Any research tool may be made available to the researcher. Preferably, as a first step, the researcher may enter the query, or his interpretation of the query, into a search engine, such as for example, GOOGLE or YAHOO. However, any number of tools, such as commercially available databases or knowledge-bases may be available to the researcher depending upon the depth and comprehensiveness of the particular installation. For example, the researcher 104 may have access to Lexis/Nexus for researching legal issues. There is essentially no limitation on the number or types of research forums available to the researcher, within the constraints of time and money.

Once the researcher finds the appropriate answer to the customer's question, the researcher may “cut and paste” the results obtained and forward such text back to the customer. Alternately, if the results of the research are not presented to the researcher in a form suitable for sending back “verbatim” to the user, the researcher may paraphrase or prepare a written response in his own words, and then send that response back to the caller.

Note that the QA operator 100 may perform a “spot-check” to evaluate some of the answered questions to determine if the researcher is performing in an acceptable manner. If the QA operator 100 determines that a question has been answered incorrectly by the researcher, the question may be redirected to the master researcher 106, who may be particularly skilled in certain subject matters. Accordingly, the question may be routed to the master researcher queue 122 via the auto-distribution sub-system 98 to handle the question.

Again, the question, answer, an indication that an answer was incorrect, and the corrected answer, may all be stored in the database 86 in the form of the maintained error table 130 so that corrective action, if needed, may be taken. Such error table entries may include pertinent information, such as the identity of the employee or operator handling the question (i.e., the transcriber or the researcher), the category of the question and the question identification (i.e., the file name).

Further, the researcher may send a particularly difficult question to the master researcher if, for example, he cannot obtain a satisfactory answer within a specific period of time, for example, three minutes. In some unusual situations, even the master researcher may not be able to obtain an answer to the question. If this situation arises, the master researcher may reply to the caller with an answer that after an exhaustive search, a suitable answer to the question cannot be found.

Referring now to FIG. 4, as generally indicated, files representing the customer query are retrieved by the get-mail application (step 200) and forwarded to the appropriate station. If the file or question is a template based question 202, it may be forwarded to an automatic content provider (step 204). Otherwise, it is a template based question, and may be forwarded to the transcriber station (step 206). After the question has been transcribed, it may be spot-checked by the QA operator (step 208) and forwarded to the researcher (step 210). Again, the results of the researcher may also be spot-checked by the QA operator (step 212). If the answer provided by the researcher is spot-checked and approved (step 220), it may be sent to the customer (step 222) via the communication device that the customer used to pose the question. If the QA operator or the researcher determines that a satisfactory answer has not been issued, the question may be sent to the master researcher (step 224). The master researcher may then either provide a suitable answer, or respond that an answer cannot be obtained. This process is repeated and the system then checks to see if additional questions need to be answered (step 226).

To enhance revenue, a caller may be sent promotional or sales material for various products, much like a targeted marketing program. The seller of such products or services may then be charged a fee for each candidate customer to whom the promotional information is sent. Alternately, the caller may be charged a fee for the questions asked, either on a flat fee basis, a timed basis, such as a fee per month, or on a question-by-question basis, perhaps with some maximum number of questions for a specific fee.

In another specific embodiment, the caller may be sent a “contextual advertisement” along with each answer provided to the user. The advertisement is said to be contextual because it may be relevant to the particular question initially posed by the caller. For example, if a caller poses a sports related question, the caller may receive along with the answer, an advertisement encouraging the caller to subscribe to a sports magazine. This could be based on each specific question or it may be based on the caller's established question history or trend. If the question or call history of a particular caller indicates that many of his questions involve housing, perhaps mortgage brokerage contextual advertisements may be sent to that caller. Of course, this assumes that the caller's communication device can receive and display text and/or graphics.

Another feature of the present invention permits a caller to send an email via a voice message where the caller may not have access to or may not be able to send an email through his particular device. For example, if the caller is using a standard cellular telephone that is not web-enabled and wishes to nonetheless transmit an email, he can accomplish this using the infrastructure of the present system. In this specific embodiment, the customer need only place a voice telephone call to the query and answer system 10 and select the option presented by the IVR of sending an email via “voice transcription.” Once the selection has been made, the caller may then “speak” the contents of the email message desired to be sent. Preferably, the caller would also dictate the email address to which to send the email. The voice file would then be digitized into a WAV file in a similar way that the questions are digitized into a WAV file, and the file may then be transcribed into text by the transcribing station. The transcriber, of course, would be able to recognize that this is a special class of message, rather than a question, and would transcribe the message from the WAV file, and then cause it to be sent to the email address requested by the user. This is essentially a special “service” provided by the system. Again, the QA operator may spot-check such special requests in a similar way in which the question transcriptions are spot-checked.

In an alternate embodiment, some questions may be able to by-pass the auto-distribution system, and hence by-pass the transcription station, research system, and the like. For example, a mail text question may be sent to the question and answer system by a caller through a BLACKBERRY wireless device, which may have the template-based JAVA application or “applet,” which may reside on the wireless device. In this situation, a template may be presented to the user, and the user may fill in the category corresponding to the question. Accordingly, the question may be sent to the system in an email format. The question and answer system may then determine that the incoming call originated from a wireless device in template format and may automatically route the call to a content provider to automatically provide the answer to the caller without human intervention. Data validation may be added to the applet residing on the caller's device to insure that the data entered by the user will be understood by the system.

Specific embodiments of a web-based method for responding to customer queries according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

1. A method for responding to customer queries comprising:
receiving one or more queries from a customer via a customer communication device;
digitizing and storing the customer query;
retrieving the stored query and transcribing the query by a human transcriber;
obtaining an answer to the transcribed query; and
transmitting the response to the customer communication device.

2. The method of claim 1 further including checking the transcribed query by a quality assurance operator prior to obtaining the response to the query.

3. The method of claim 2 wherein the quality assurance operator spot checks work product prepared by the transcriber.

4. The method of claim 1 wherein if the customer query is in the form of a voice question, said customer query formatted and stored as a WAV file.

5. The method of claim 1 wherein the step of obtaining the response includes: providing the transcribed query to a human researcher and performing research by the human researcher to obtain an answer to the query.

6. The method of claim 5 wherein the human researcher accesses search engines, databases, and/or knowledge-bases to obtain the answer.

7. The method of claim 5 wherein a quality assurance operator spot checks work product provided by the researcher prior to transmitting the answer to the customer.

8. The method of claim 5 wherein the query is routed to the human researcher based upon a level of expertise of the researcher corresponding to the query.

9. The method of claim 5 wherein the query is routed to the human researcher based upon a level of idle time corresponding to the researcher.

10. The method of claim 5 wherein the query is routed to a master researcher if an answer to the query cannot be provided by the researcher within a predetermined period of time.

11. The method of claim 5 wherein the query is routed to a master researcher if a quality assurance operator determines that an answer to the query provided by the researcher is not acceptable.

12. The method of claim 5 wherein customer query is in the form of a free form query that requires the human researcher to perform the research.

13. The method of claim 12 wherein the free form query is assigned a free form category based on a popularity identifier of the query.

14. The method of claim 13 wherein the free form query is routed to a researcher having skill dealing with the query corresponding to the popularity identifier.

15. The method of claim 1 wherein customer query is formatted in the form of a template corresponding to one of a plurality of predetermined categories selected by the customer.

16. The method of claim 15 wherein the customer query is formatted as a WAV file having a file name that includes at least an indication of the category selected by the customer.

17. The method of claim 15 wherein the predetermined categories are selected from the group consisting of weather, stock quotes, sports, directory assistance, direction, horoscope, restaurants, airline fares, airline flight times, accommodations, movie times, comparison shopping, gaming and free form.

18. The method of claim 15 wherein the customer selects one category from the plurality of predetermined categories in response to prompts provided by an interactive voice response device, the selected category defining the corresponding template.

19. The method of claim 18 based on the category selected by the customer, the customer enters additional data to further define the query.

20. The method of claim 19 wherein the customer query is transmitted to a content provider to automatically obtain an answer to the query without human research.

21. A method for responding to customer queries using a communication network comprising:
receiving one or more queries from a customer via a customer communication device;
digitizing and storing the customer query;
retrieving the stored query and transcribing the query by a human transcriber;
routing the transcribed query to a human researcher to obtain an answer to the query; and
transmitting the answer to the customer in text format to the customer communication device.

22. The method of claim 21 wherein customer query is in the form of a free form query that requires the human researcher to perform investigation and research.

23. The method of claim 21 further including checking the transcribed query by a quality assurance operator prior to routing the transcribed query to researcher.

24. The method of claim 21 further including checking the response to the query by a quality assurance operator prior to transmitting the response to the customer.

25. A method for responding to customer queries using a communication network comprising:
receiving one or more verbal queries from a customer via a customer communication device;
digitizing and storing the verbal query;
retrieving the stored query and transcribing the query by a human transcriber;
spot-checking the transcribed query by a quality assurance operator;
routing the transcribed query to a human researcher;
the researcher performing research using search engines, databases, and/or knowledge-bases to obtain an answer to the query;
spot-checking the answer by a quality assurance operator; and
transmitting the answer to the customer in text format to the customer communication device.
